(19) United States
(12) Patent Application Publication
(10) Pub. No.: US 2005/0128610 A1
(43) Pub. Date: Jun. 16, 2005

(54) Rearview mirror assembly including a housing having a wiring cover

(76) Inventors: Brian R. Parker, Zeeland, MI (US); Jeremy A. Fogg, Holland, MI (US)

Correspondence Address: PRICE, HENEVELD, COOPER, DEWITT, & LITTON,;LLP/GENTEX CORPORATION, 695 KENMOOR, S.E., P O BOX 2567, GRAND RAPIDS, MI, 49501, US

(21) Appl. No.: 10/980,854

(22) Filed: Nov. 3, 2004

Related U.S. Application Data
(60) Provisional application No. 60/516,890, filed on Nov. 3, 2003.

(51) Int. Cl. G02B 7/182

(52) U.S. Cl. 359/871; 359/879

(57) ABSTRACT

An interior rearview assembly comprising a rearview element, a rearview housing supporting the rearview element and a mount connected to the rearview housing and configured to support the rearview housing. The rearview housing has a recess with a first area for accepting a portion of the mount and a second area for accepting a wire harness therein. The rearview housing further has a cover for selectively covering the second area.

### CROSS-REFERENCE TO RELATED APPLICATION

This application claims the benefit of U.S. Provisional Application No. 60/516,890 entitled REARVIEW MIRROR ASSEMBLY INCLUDING A HOUSING HAVING A WIRING COVER, which was filed Nov. 3, 2003, the entire contents of which are hereby incorporated herein by reference.

### BACKGROUND OF THE INVENTION

The present invention generally relates to a rearview assembly for a vehicle, and more particularly relates to an interior rearview assembly for a vehicle.

Interior rearview assemblies have become a very popular location for the inclusion of electronics such as displays, compasses, imagers, map lamps, sensors, and user interfaces. In addition, rearview assemblies have been made employing an electrochromic rearview assembly, which has a reflectivity that varies in response to the glare impinging upon the rearview assembly. Such an electrochromic mirror and each of the above-noted electronic components require power and, in some configurations, connections to other components and controllers within the vehicle.

FIG. 1 shows one example of a typical rearview rearview housing 10 having a plug receptacle opening 12 in the housing that is laterally spaced from the mounting bracket 14. The receptacle opening 12 in housing 10 is sized so as to receive and securely engage a plug 16 to which a wiring harness 18 is attached. The wiring harness 18 may be secured to the mounting bracket 14 by a clip or the like and covered by a wire cover that extends along the windshield to the headliner or overhead console from which the wire harness 18 extends. The construction shown in FIG. 1 is cost efficient for the mirror supplier as it does not require any wires to be run through or out of the rearview assembly.

FIG. 2 shows another example of a typical rearview assembly, which has a wiring harness 28 extending from within rearview rearview housing 20 through mount 24. Wiring harness 28 is terminated with a connector plug 26 which may be connected to the corresponding plug of a wiring harness extending from the vehicle headliner or overhead console. While the construction shown in FIG. 2 is an elegant solution for hiding the wiring extending from the rearview assembly, the cost of the rearview assembly increases due to the existence of the wiring and the plug as well as the manufacturing time and expense required to extend the wiring 28 through the mount 24. An example of through-ball wiring is disclosed in commonly assigned U.S. Pat. No. 5,984,482.

Yet another approach is shown in FIG. 3. In this construction, rearview housing 30 includes a small opening 32 proximate and above mounting mechanism 34. Wiring 38 extends from within rearview housing 30 through opening 32 along the stem of mounting mechanism 34, and terminates with a connector plug 36. Connector plug 36 may be plugged into a corresponding plug of a wire harness extending within the headliner or overhead console. Although this construction is somewhat less costly than the construction shown in FIG. 2, it is still more costly than the construction shown in FIG. 1 and the wiring 38 extending from the rearview housing 30 is not as well hidden from view as it is in FIG. 2. In addition, the rearview assembly manufacturer must still assemble the rearview mirror with wiring extending from the rearview assembly.

Accordingly, there exists a need for a rearview assembly providing a low cost construction that is aesthetically pleasing without requiring a rearview assembly supplier to manufacture the mirror assembly such that wiring runs from within the housing and is terminated with a plug connector.

### SUMMARY OF THE PRESENT INVENTION

An aspect of the present invention is to provide an interior rearview assembly comprising a rearview element, a rearview housing supporting the rearview element and a mount connected to the rearview housing and configured to support the rearview housing. The rearview housing has a recess with a first area for accepting a portion of the mount and a second area for accepting a wire harness therein. The rearview housing further has a cover for selectively covering the second area.

Another aspect of the present invention is to provide an interior rearview assembly comprising a rearview element, a rearview housing supporting the rearview element, a mount and a wire harness. The rearview housing has a recess with a first area and a second area. The rearview housing further has a wire connection. The mount is connected to the rearview housing to the rearview housing within the first area of the recess. The wire harness is inserted into the second area and removably connected to the wire connection.

Yet another aspect of the present invention is to provide a method of assembling a rearview assembly comprising providing a rearview housing having a recess in a rear end thereof, with the recess having a first area and second area. The method also includes inserting a mount into the first area of the recess, connecting the mount to the rearview housing, inserting a wire harness into the second area and positioning a door over the second area to cover the second area.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG: 1 is an elevational view showing the rear of a first conventional rearview assembly;

FIG. 2 is a cross-sectional view showing a portion of a second conventional rearview assembly;

FIG. 3 is an elevational view showing the rear of a third conventional rearview assembly;

FIG. 4 is a perspective view of the rear of a rearview assembly constructed in accordance with a first embodiment of the present invention;

FIG. 5 is a close-up perspective view of a portion of the rearview assembly shown in FIG. 4;

FIG. 6 is a perspective view of the rear of a rearview assembly constructed in accordance with a second embodiment of the present invention;

FIG. 7 is a close-up perspective view of a portion of the rear of the rearview assembly shown in FIG. 6;

FIG. 8 is a close-up perspective view of a portion of the rearview assembly shown in FIGS. 6 and 7 with the wiring cover removed;

FIG. 9 is an elevational rear view of the rearview assembly shown in FIGS. 6 and 7 with the wiring cover fully closed;

FIG. 10 is a perspective view showing the outer surface of the wiring cover employed in the second embodiment of the present invention;

FIG. 11 is a perspective view showing the underside of the wiring cover shown in FIG. 10;

FIG. 12 is another perspective view showing the underside of the wiring cover shown in FIGS. 10 and 11;

FIG. 13 is a perspective view of the rear of a rearview assembly constructed in accordance with a third embodiment of the present invention;

FIG. 14 is a close-up perspective view of a portion of the rearview assembly shown in FIG. 13;

FIG. 15 is a perspective view of the rear of the rearview assembly shown in FIG. 13 with the wiring cover fully closed;

FIG. 16 is a close-up perspective view of a portion of the rearview assembly shown in FIG. 15;

FIG. 17 is a close-up perspective view of a portion of the rearview assembly shown in FIGS. 13 and 15 with the wiring cover fully removed;

FIG. 18 is an elevational rear view of the rearview assembly shown in FIGS. 13 and 15 with the cover fully closed;

FIG. 19 is an elevational rear view of the rearview assembly shown in FIGS. 13 and 15 with the wiring cover opened;

FIG. 20 is a perspective view showing the outer surface of a wiring cover used with the rearview assembly shown in FIGS. 13-19;

FIG. 21 is a perspective view showing the inner surface of the wiring cover shown in FIG. 20;

FIG. 22 is a perspective view of the inner surface of the wiring cover shown in FIGS. 20 and 21;

FIG. 23 is a perspective view of the inside of a modified cover that may be used with the rearview assembly shown in FIGS. 13-19;

FIG. 24 is a cross-sectional side view of the rearview assembly shown in FIG. 4; and

FIG. 25 is a cross-sectional top view of the rearview assembly shown in FIG. 4.

### DETAILED DESCRIPTION OF THE INVENTION

Reference will now be made in detail to the present preferred embodiments of the invention, examples of which are illustrated in the accompanying drawings. Wherever possible, the same reference numerals will be used throughout the drawings to refer to the same or like parts.

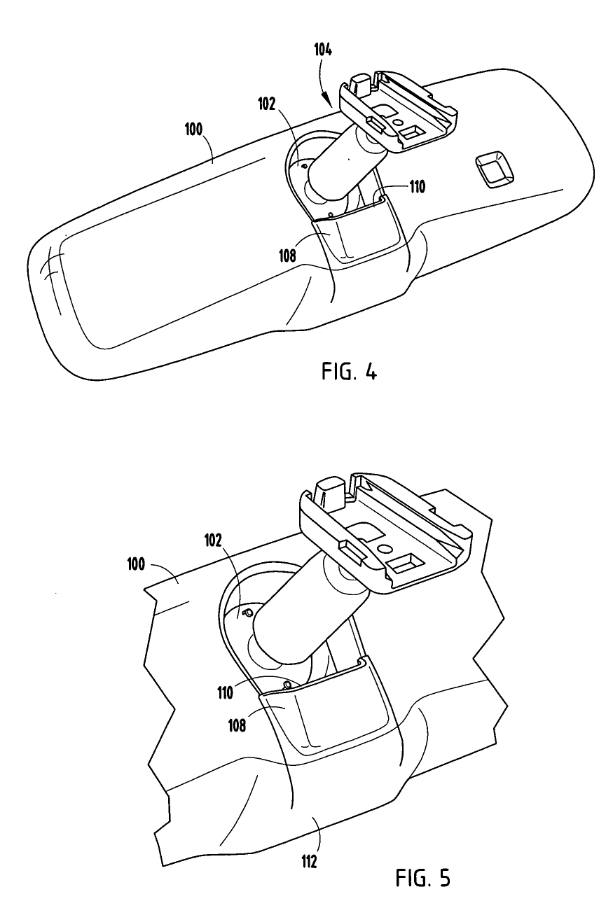

For purposes of description herein, the terms “upper,” “lower,” “right,” “left,” “rear,” “front,” “vertical,” “horizontal,” “top,” “bottom,” and derivatives thereof shall relate to the invention as viewed in FIG. 4. However, it is to be understood that the invention may assume various alternative orientations, except where expressly specified to the contrary. It is also to be understood that the specific device illustrated in the attached drawings and described in the following specification is simply an exemplary embodiment of the inventive concepts defined in the appended claims. Hence, specific dimensions, proportions, and other physical characteristics relating to the embodiment disclosed herein are not to be considered as limiting, unless the claims expressly state otherwise.

FIGS. 4, 5, 24, and 25 show a rearview assembly constructed in accordance with the first embodiment of the present invention. As illustrated therein, the rearview assembly includes a housing 100 in which a rearview assembly 103 is housed. A mounting mechanism 104 extends from the rear of the rearview housing 100 for connecting the rearview assembly either to the inside surface of the vehicle windshield or to the roof structure of the vehicle. The particular mounting mechanism 104 shown in the drawings is what is known as a “double ball” mount for mounting the rearview assembly to the inner surface of the vehicle windshield. Although a double ball mount is shown, the present invention may be utilized with rearview assemblies having virtually any form of mounting mechanism.

The illustrated rearview assembly 103 of the present invention can comprise an electrochromic (EC) mirror subassembly having a front glass element and a rear glass element. The illustrated front glass element and the rear glass element are preferably less than 2.2 mm, or more preferably less than about 1.6 mm down to about 1.1 mm. A more detailed description of reflective elements 14 having glass elements of a thickness of 1.1 mm is disclosed in U.S. Pat. No. 6,195,194 entitled LIGHTWEIGHT ELECTROCHROMIC MIRROR, the entire contents of which are hereby incorporated herein by reference. The illustrated rearview assembly 103 includes an electrochromic (EC) material positioned between the front glass element and the rear glass element. Furthermore, a reflector material is preferably located on either the front surface or the rear surface of the rear glass element, depending upon the type of the mirror subassembly. The EC material is preferably a solution phase (sometimes called herein a “liquid-phase” or “gel-type”) EC material, as disclosed in U.S. Pat. No. 4,902,108 entitled SINGLE-COMPARTMENT, SELF-ERASING, SOLUTION-PHASE ELECTROCHROMIC DEVICES, SOLUTIONS FOR USE THEREIN, AND USES THEREOF and U.S. Pat. No. 5,278,693 entitled TINTED SOLUTION-PHASE ELECTROCHROMIC MIRRORS, the entire contents of both of which are hereby incorporated herein by reference. In addition, a hybrid system where part of the electrochromic medium is solid-state and part is solution phase is also contemplated. Solution-phase materials, because of their liquidic or flowable properties, do not rigidly bond the front glass element and the rear glass element together like a completely solid-state EC medium. As a result, the stiffness of the reflective element using 1.1 mm thick glass elements and a solution-phase EC material is more flexible than an EC mirror subassembly having 1.1 mm thick glass elements and a solid-state phase EC material because, in the rearview assembly 103 having solid-state phase EC material, the thick glass elements are bonded together in a manner that causes them to bend much like a single glass element having their total thickness. Contrastingly, the rearview assembly 103 with the solution phase EC material bends in a complex manner wherein the thin glass elements bend simultaneously but independently and separately and wherein the solution phase EC material ebbs and flows somewhat in reaction to the stress. The net result is that the mirror subassembly with solution phase EC material tends to be more flexible and concurrently more sensitive to impact than the mirror subassembly with solid-state phase EC material, even where the front and rear glass elements have the same thickness and other properties.

As used herein, a “rearview assembly” 103 is a structure that provides an image of a scene to the rear of driver. As commonly implemented, such rearview assemblies 103 include a rearview element such as a prismatic mirror or the electrochromic rearview element described above. The rearview assembly 103 may additionally or alternatively include a rearview element in the form of an electronic display that displays an image as sensed by a camera or other image sensor (see, for example, commonly assigned U.S. Pat. No. 6,550,949 entitled “SYSTEMS AND COMPONENTS FOR ENHANCING REAR VISION FROM A VEHICLE,” filed on Sep. 15, 1998, by Frederick T. Bauer et al., the entire disclosure of which is incorporated herein by reference). Thus, a “rearview assembly” need not include a rearview element. In the embodiments described below, an electrochromic rearview assembly is shown and described. It will be appreciated, however, that such embodiments could be modified to include a display and no rearview element.

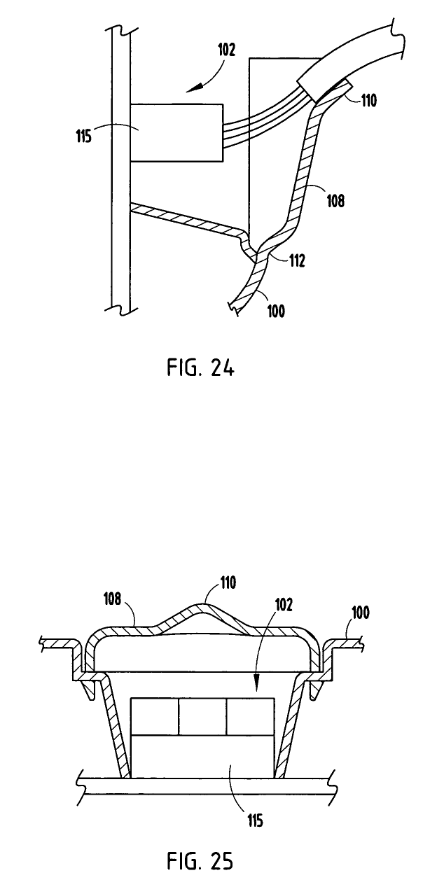

As shown in the drawings, the rearview assembly of the present invention includes a recess 102 in the rear surface of housing 100. Mounting mechanism 104 is connected to a ball or a socket connected within recess 102. The recess 102 extends further below the area in which mounting mechanism 104 is attached where an aperture 106 (see FIG. 24) is provided for receiving a plug or wires at the end of a wiring harness 105 that extends from the vehicle headliner or overhead console. Although recess 102 is shown as including aperture 106 at a bottom portion thereof, aperture 106 could be located above the mounting mechanism or to the side thereof. Further still, aperture 106 may be physically separated from recess 102 or provided in a different recess.

Housing 100 further includes a wiring cover 108 that covers a portion of recess 102, and specifically covers aperture 106. As best shown in FIGS. 24 and 25, wiring cover 108 includes a wire basket 110 that projects outward near the top edge of cover 108. Wire basket 110 provides clearance for the wire harness 105 to bend upward and then rearward along the mounting mechanism 104. The wire basket 110 is designed to resemble a pouring spout on a water pitcher so as to provide sufficient clearance for the wire harness 105 while also concealing the wires to the greatest extent possible.

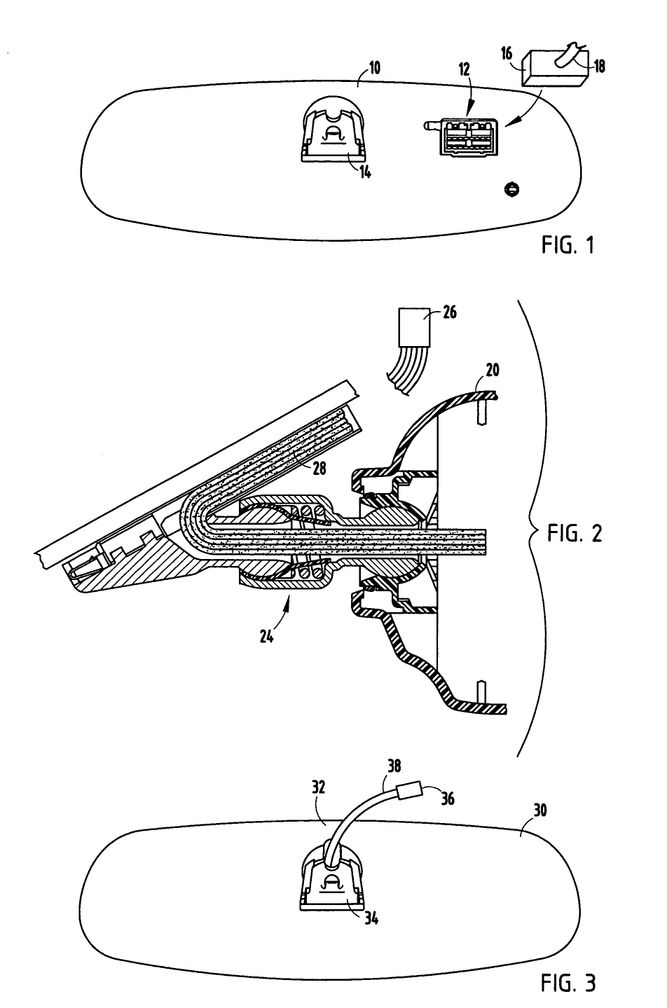

By providing the connection for the wire harness 105 as close as possible to the mounting mechanism 104, several advantages are obtained. First, it is easier to conceal the wiring extending from the rearview rearview housing 100 by running it along the underside of the mounting mechanism 104. Further, the distance between the wire connection point and the pivot point mounting mechanism is minimized compared to conventional constructions, for example, such as that shown in FIG. 1. By providing a wiring cover 108 that conceals the connection of the wires from the wire harness 105 to the rearview assembly, a rearview assembly may be constructed that is aesthetically more pleasing while also being less costly than conventional constructions such as those shown in FIGS. 2 and 3. Specifically, the rearview assembly manufacturer need not include any wiring that extends outward from the rearview assembly and which terminates in a plug connector. Moreover, no complicated assembly is required.

In the first embodiment shown in FIGS. 4, 5, 24, and 25, wiring cover 108 is formed as an integral component of housing 100. Specifically, cover 108 is molded integrally with housing 100 and includes a living hinge 112 which extends along one side edge or one or more corners of cover 108. Although shown as extending along a bottom edge of cover 108, living hinge 112 may extend along the entire length or a portion of any of the sides of cover 108. As will be described further below in connection with the other embodiments, cover 108 may include resilient tabs for snapping the cover into place on the housing after the wires have been connected to the rearview assembly so as to hold and secure cover 108 in the position shown in FIGS. 4 and 5. By providing a living hinge 112, cover 108 is attached to rearview housing 100 when it is shipped to the vehicle manufacturer. This avoids the possibility that the cover 108 may become lost or detached from the rearview assembly. In addition, it eliminates the need for a separate part number for the cover. Thus, all the vehicle manufacturer need do is attach the rearview assembly to the vehicle, connect the wires of the wiring harness to the wire connector 115 or otherwise plug into a plug connector in aperture 106, and snap the cover 108 shut so as to cover the wiring connection within the rearview housing while also pushing the wiring harness 105 upward towards mounting mechanism 104 so as to reduce its visibility.

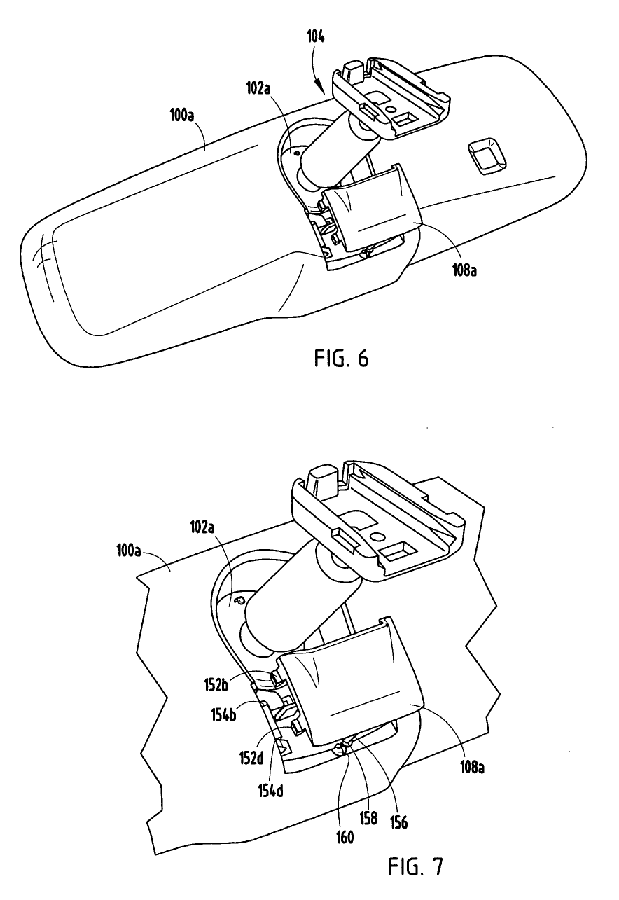

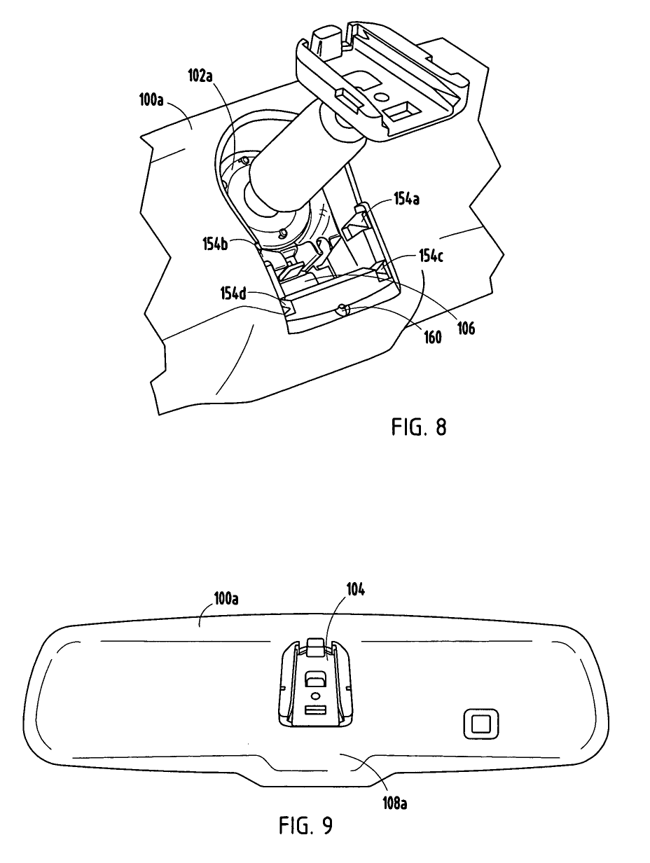

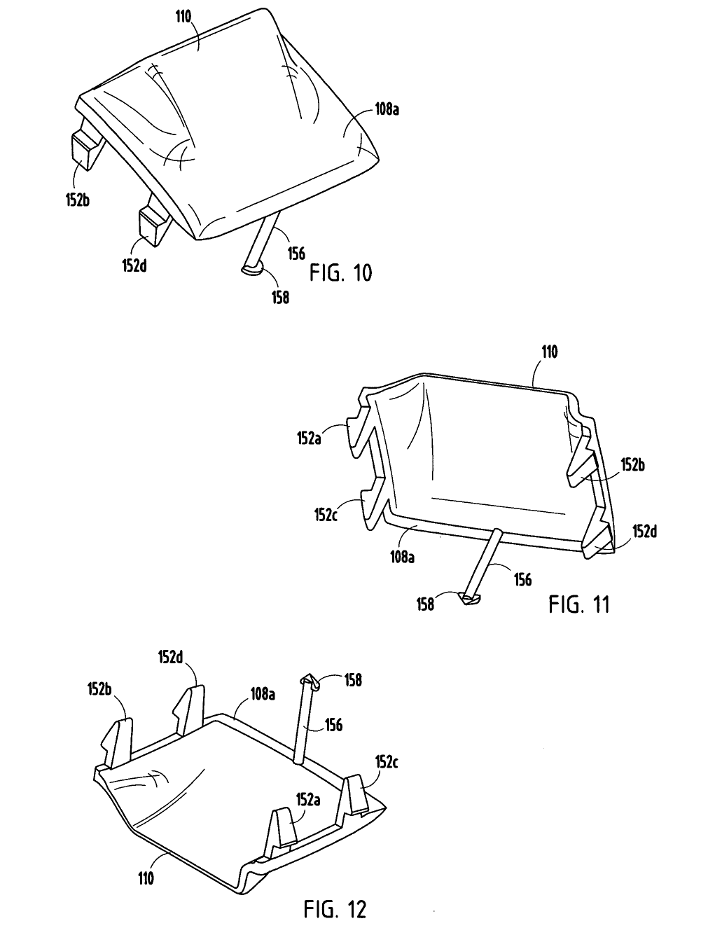

A rearview assembly constructed in accordance with a second embodiment of the present invention is shown in FIGS. 6 through 12. This embodiment of the present invention differs from the first embodiment in that wiring cover 108a is not an integral component of housing 100a and is not connected by any living hinge. As best shown in FIGS. 7, 8 and 11, cover 108a includes one or more retaining structures, such as resilient tabs 152a, 152b, 152c and 152d that extend from a forward inner edge of cover 108a, and which are received in respective corresponding slots 154a, 154b, 154c and 154d formed in housing 100a in the periphery of recess 102a in the vicinity of aperture 106. Tabs 152a through 152d may thus be snapped into place as the cover is inserted in the appropriate position. Although resilient tabs are shown, other forms of retaining structures may be used including similar structures as are used to attach battery compartment doors to an electronic device. For example, a lip may be provided on one or more edges of the cover with one or more snaps, tabs, clips, or hooks provided at another side. As yet another example, a hinge or pivoting retaining structure may be used along one or more sides of the cover.

Cover 108a may further include a post 156 having a semi-conical or semi-circular key 158 at its distal end which is configured for insertion into a corresponding semi-circular slot 160 in housing 100a. Post 156 preferably has a length that is significantly greater than that of tabs 152a-152d such that key 158 may be inserted into the semi-circular opening of slot 160 and then the cover may be rotated about post 156 within slot 160 to hold cover 108a to housing 100a while leaving the aperture 106 exposed for connection of the appropriate plug or wires. By providing a non-symmetrically shaped key 158 and providing a correspondingly shaped slot 160, when cover 108a is rotated to expose plug aperture 106, the shape of key 158 and slot 160 prevents the cover from being removed from housing 100a when in this position. Thus, the cover 108a may be attached to housing 100a prior to shipping using post 156a as a tether while retaining cover 108a in the rotated position with aperture 106 exposed. It will be appreciated that slot 160 and key 158 may have any shape.

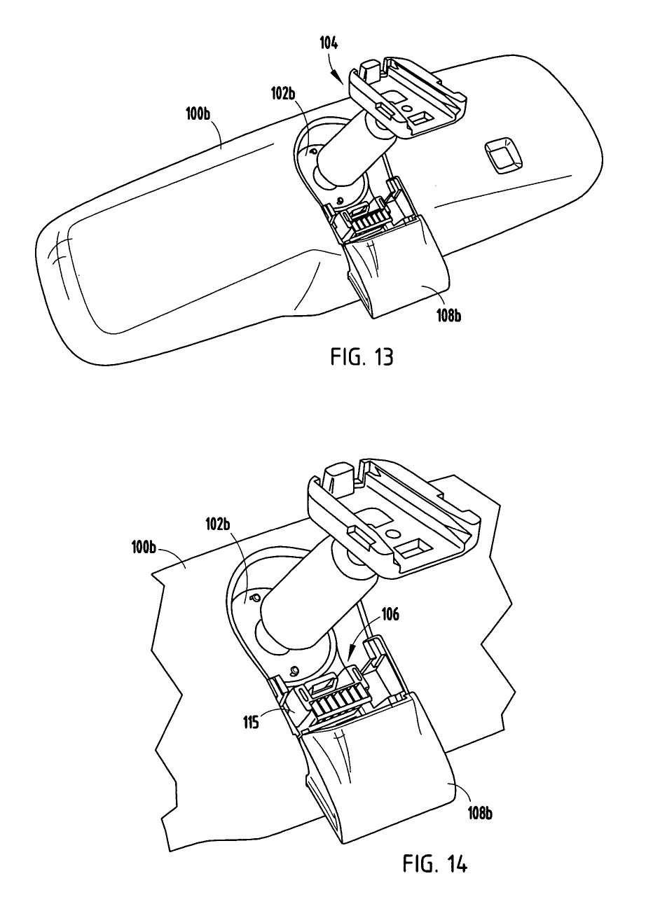

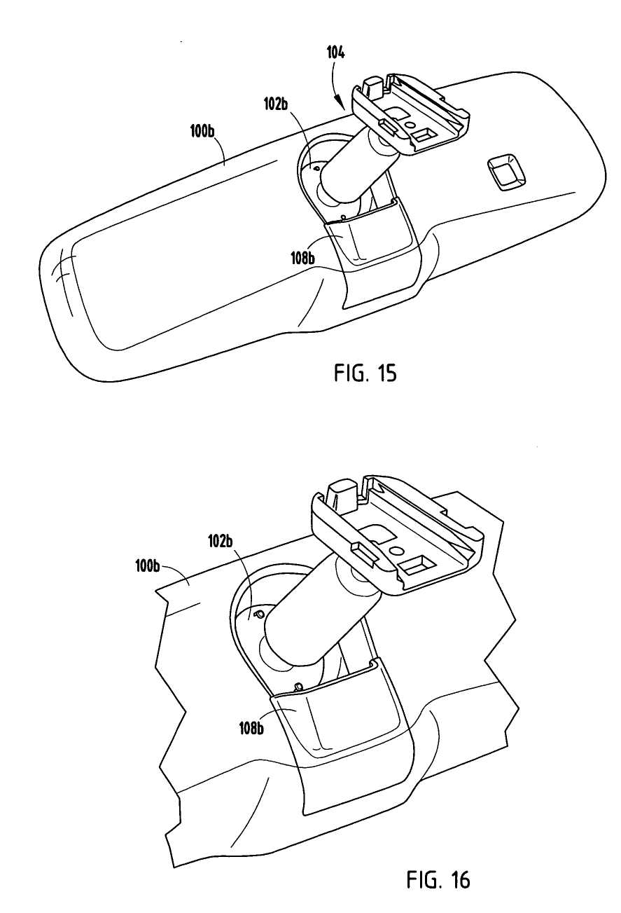

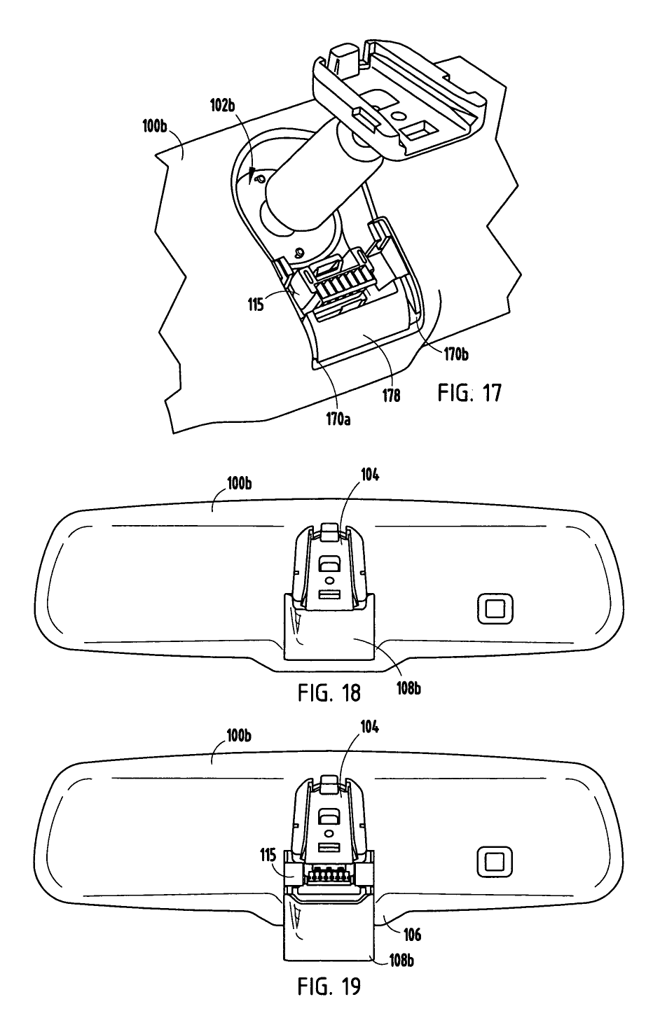

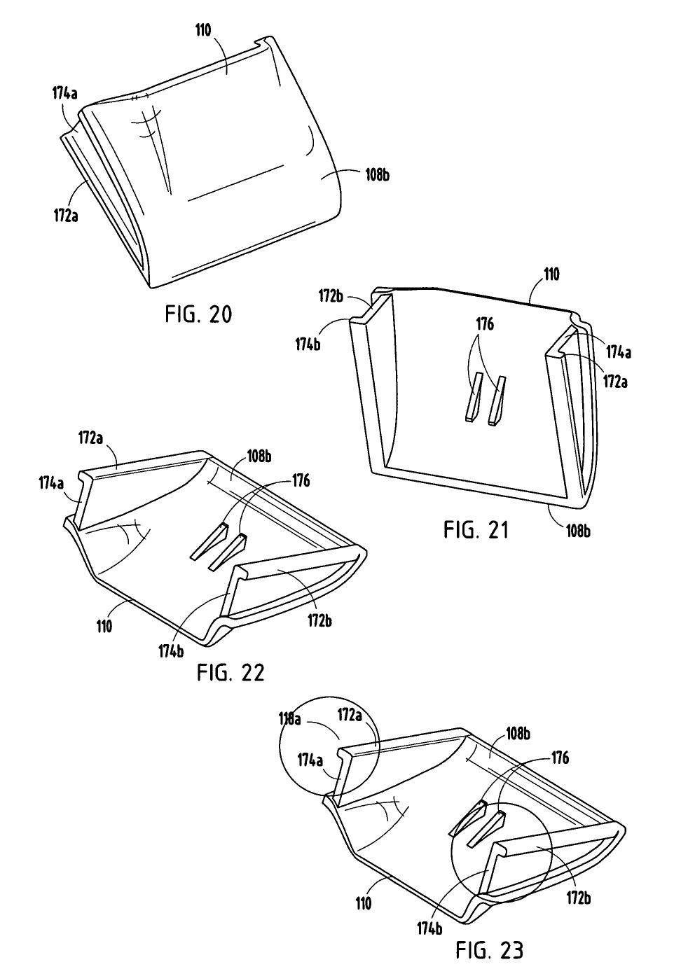

A third embodiment of the present invention is shown in FIGS. 13 through 23. Unlike the first embodiment, cover 108b of the third embodiment is not integrally formed with housing 100b, but rather is separately formed for subsequent attachment. Unlike the second embodiment, cover 108b of the third embodiment does not include resilient tabs for snapping the cover into the housing, but rather includes a sliding configuration. Specifically, as shown in FIG. 17, housing 100b includes two slots 170a and 170b for receiving corresponding rims 172a and 172b formed on the forward edge of cover 108b. More specifically, cover 108b includes a pair of forwardly extending side walls 174a and 174b which extend generally parallel with one another forwardly along each lateral side edge of cover 108b. Rims 172a and 172b are provided on the forwardmost edge of sidewalls 174a and 174b. Rims 172a and 172b extend laterally outward along the forwardmost edge of sidewalls 174a and 174b.

Cover 108b may additionally include one or more retention mechanisms such as catches 176, which extend forward from the inner surface of cover 108b. Catches 176 are ramped so as to easily slide over a riser 178 provided in housing 100b just below the wire connector 115. In this manner, as cover 108b is slid upward over connector 115, the upper and forward ramped surfaces of catches 176 slide over the rear surface of riser 178 until cover 108b is fully seated over connector 115 at which point the ramped surfaces of ramped catches 176 slide past the upper extent of riser 178. At this point, the bottom surfaces of catches 176 are deflected forward so as to engage the upper surface of riser 178 and thereby latch cover 108b in place. Although catches 176 are illustrated as sliding over and securing to a surface of riser 178, catches 176 may latch onto or into any surface on or within rearview housing 100b. Further, any other form of retention mechanism may be used to secure the cover in place.

As shown in FIG. 23, cover 108b may further be modified to include a pair of detents 118a and 118b which are provided at the uppermost ends of rims 172a and 172b, respectively. Detents 118a and 118b are provided as secondary locking mechanisms which prevent cover 108b from being disconnected from housing 100b when moved to its lowermost position. Again, this is beneficial in that cover 108b may be connected to housing 100b when shipped from the supplier. Indents may be provided in the slots 170a and 170b to further latch the cover in place when moved to a fully closed position.

It is to be understood that variations and modifications can be made on the aforementioned structure without departing from the concepts of the present invention. For example, the carrier could comprise any three dimensional object and does not have to comprise a plate. Furthermore, it is contemplated that the circuit board and/or the heater could be located between the carrier and the reflective element for any of the carriers of the present invention. Moreover, it is to be understood that such concepts are intended to be covered by the following claims unless these claims by their language expressly state otherwise.

1. An interior rearview assembly comprising:
a rearview element;
a rearview housing supporting the rearview element; and
a mount connected to the rearview housing and configured to support the rearview housing;
the rearview housing having a recess with a first area for accepting a portion of the mount and a second area for accepting a wire harness therein, the rearview housing further having a cover for selectively covering the second area.

2. The interior rearview assembly of claim 1, wherein:
the rearview element comprises an electrochromic mirror subassembly including a front glass element and a rear glass element, with electrochromic material located between the front glass element and the rear glass element.

3. The interior rearview assembly of claim 1, wherein:
the cover includes a spout for easily routing the wire harness into the second area.

4. The interior rearview assembly of claim 1, wherein:
the first area and the second area are contiguous and uninterrupted.

5. The interior rearview assembly of claim 1, wherein:
the first area and the second area are separated by a wall.

6. The interior rearview assembly of claim 1, wherein:
the cover is connected to the rearview housing by a living hinge.

7. The interior rearview assembly of claim 1, wherein:
the cover is separate from the rearview housing.

8. The interior rearview assembly of claim 7, wherein:
the rearview housing includes slots in the second area; and
the cover includes projecting tabs configured to be inserted into the slots to connect the cover to the rearview housing.

9. The interior rearview assembly of claim 8, wherein:
the cover includes a post having a key adjacent an end thereof;
the rearview housing includes a key-shaped opening adjacent the second area for accepting the key of the cover, whereby the cover can be operatively connected to the rearview housing when the key is turned in the key-shaped opening and when the tabs are not inserted into the slots.

10. The interior rearview assembly of claim 7, wherein:
the cover is slidably connected to the rearview housing.

11. The interior rearview assembly of claim 10, wherein:
the rearview housing includes slots; and
the cover includes a plurality of rims configured to be slid into the slots to connect the cover to the rearview housing.

12. The interior rearview assembly of claim 10, wherein:
the cover includes at least one detent for maintaining the cover on the rearview housing after the cover is slid into position.

13. An interior rearview assembly comprising:
a rearview element;
a rearview housing supporting the rearview element, the rearview housing having a recess with a first area and a second area, the rearview housing further having a wire connection; and
a mount connected to the rearview housing within the first area of the recess; and
a wire harness inserted into the second area and removably connected to the wire connection.

14. The interior rearview assembly of claim 13, wherein:
the rearview element comprises an electrochromic mirror subassembly including a front glass element and a rear glass element, with electrochromic material located between the front glass element and the rear glass element.

15. The interior rearview assembly of claim 13, wherein:
the cover includes a spout for easily routing the wire harness into the second area.

16. The interior rearview assembly of claim 13, wherein:
the first area and the second area are contiguous and uninterrupted.

17. The interior rearview assembly of claim 13, wherein:
the first area and the second area are separated by a wall.

18. The interior rearview assembly of claim 13, wherein:
the cover is connected to the rearview housing by a living hinge.

19. The interior rearview assembly of claim 13, wherein:
the cover is separate from the rearview housing.

20. The interior rearview assembly of claim 19, wherein:
the rearview housing includes slots in the second area; and
the cover includes projecting tabs configured to be inserted into the slots to connect the cover to the rearview housing.

21. The interior rearview assembly of claim 20, wherein:
the cover includes a post having a key adjacent an end thereof;
the rearview housing includes a key-shaped opening adjacent the second area for accepting the key of the cover, whereby the cover can be operatively connected to the rearview housing when the key is turned in the key-shaped opening and when the tabs are not inserted into the slots.

22. The interior rearview assembly of claim 19, wherein:
the cover is slidably connected to the rearview housing.

23. The interior rearview assembly of claim 19, wherein:
the rearview housing includes slots; and
the cover includes a plurality of rims configured to be slid into the slots to connect the cover to the rearview housing.

24. The interior rearview assembly of claim 19, wherein:
the cover includes at least one detent for maintaining the cover on the rearview housing after the cover is slid into position.

25. A method of assembling a rearview assembly comprising:
providing a rearview housing having a recess in a rear end thereof, the recess having a first area and second area;
inserting a mount into the first area of the recess;
connecting the mount to the rearview housing;
inserting a wire harness into the second area; and
positioning a cover over the second area to cover the second area.

26. The method of assembling the rearview assembly of claim 25, wherein:
the rearview element comprises an electrochromic mirror subassembly including a front glass element and a rear glass element, with electrochromic material located between the front glass element and the rear glass element.

27. The method of assembling the rearview assembly of claim 25, wherein:
the cover includes a spout for easily routing the wire harness into the second area.

28. The method of assembling the rearview assembly of claim 25, wherein:
the first area and the second area are contiguous and uninterrupted.

29. The method of assembling the rearview assembly of claim 25, wherein:
the first area and the second area are separated by a wall.

30. The method of assembling the rearview assembly of claim 25, wherein:
the cover is connected to the rearview housing by a living hinge.

31. The method of assembling the rearview assembly of claim 25, wherein:
the cover is separate from the rearview housing.

32. The method of assembling the rearview assembly of claim 31, wherein:
the rearview housing includes slots in the second area;
the cover includes projecting tabs; and
positioning the cover includes inserting the tabs into the slots of the rearview housing.

33. The method of assembling the rearview assembly of claim 32, wherein:
the cover includes a post having a key adjacent an end thereof;
the rearview housing includes a key-shaped opening adjacent the second area for accepting the key of the cover, whereby the cover can be operatively connected to the rearview housing when the key is turned in the key-shaped opening and when the tabs are not inserted into the slots.

34. The method of assembling the rearview assembly of claim 31, wherein:
positioning the cover includes sliding the cover onto the rearview housing.

35. The method of assembling the rearview assembly of claim 34, wherein:
the rearview housing includes slots;
the cover includes a plurality of rims; and
sliding the cover includes sliding the rims into the slots of the rearview housing.

36. The method of assembling the rearview assembly of claim 34, wherein:
the cover includes at least one detent for maintaining the cover on the rearview housing after the cover is slid into position.
